(19) United States
(12) Patent Application Publication
(10) Pub. No.: US 2003/0012202 A1
(43) Pub. Date: Jan. 16, 2003

(54) Network interconnection method, network interconnection apparatus and system using network interconnection apparatus

(75) Inventor: Shoji Fukutomi, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THE FURUKAWA ELECTRIC CO., LTD., Tokyo (JP)

(21) Appl. No.: 10/020,224

(22) Filed: Dec. 18, 2001

(30) Foreign Application Priority Data
Jul. 16, 2001 (JP) 2001-215876

(51) Int. Cl. H04L 12/56

(52) U.S. Cl. 370/395.52; 370/401; 370/395.3

(57) ABSTRACT

An edge router adds a tag specifying a VLAN, to which a receiver host belongs, for receiving a multicast packet and transmits the multicast packet to a subordinate router one by one, and the subordinate router receiving the multicast packet copies this multicast packet and transfers the copied multicast packet to each receiver host belonging to the VLAN, thereby reducing a line occupancy rate and improving band utilization efficiency.

### FIELD OF THE INVENTION

The present invention relates to a network interconnection method by a combination of tag-VLAN and multicast delivery, an apparatus therefor and a system using the apparatus.

### BACKGROUND OF THE INVENTION

In a certain conventional network interconnection system, as shown in, for example, FIG. 15, a backbone network 1 is connected to hosts 20 to 23 serving as receivers such as personal computers (to be referred to as “receiver hosts” hereinafter) through a network interconnection apparatus 10 consisting of an edge router 11 and a plurality of subordinate routers 12 to 14.

According to this system, the edge router 11 has a switching function of layer 3 level (to be referred to as “L3” hereinafter) so as to separate the traffics of the receiver hosts 20 to 23 which are users and the edge router 11 transmits a packet received from the upstream backbone network 1 using a tag VLAN. Each of the subordinate routers 12 to 14 has a switching function of layer 2 level (to be referred to as “L2” hereinafter) and relays the packet received from the edge router 11 to the downstream receiver hosts 20 to 23 through customer edge routers (to be referred to as “CE routers” hereinafter) serving as relay units using port LANs (PVLANs), respectively.

In such a system configuration, if a multicast packet is transmitted from, for example, a sender host, not shown, existing in the backbone network 1, tags corresponding to the respective users are allocated to IGMP (Internet Group Management Protocol) reports from the receiver hosts 20 to 23 and the edge router 11 copies a multicast stream and transmits the copied multicast stream to the respective receiver hosts 20 to 23 with the different tags.

According to the conventional system stated above, however, even if a plurality of receiver hosts in the same multicast group are connected to each of the subordinate routers 12 to 14, the edge router 11 is required to change tags according to the hosts and repeatedly transmit the same content of the packet to the respective receiver hosts 20 to 23. Due to this, a line occupancy rate is disadvantageously increased and band utilization efficiency is thereby disadvantageously deteriorated. For example, if the receiver hosts connected downstream of the edge router 11 builds different VLAN's and receive the same multicast stream, line transmission rate is 10 Mbps, the number of the receiver hosts is 20 and a stream is delivered at a transmission rate of 1 Mbps, then a stream at 20 Mbps is output to each line of 10 Mbs at the worst. As a result, congestion disadvantageously occurs.

Considering these disadvantages, a packet can be relayed by, for example, individually L3-connecting the subordinate routers 12 to 14. In this case, if the receiver hosts 20 to 23 are allocated user IP addresses “192.168.1.1/30”, “192.168.1.5/30”, “192.168.1.9/30” and “192.168.1.13/30”, respectively, it is necessary to allocate subnets to the connected receiver hosts, respectively. As for the receiver host 20, for example, a network address is “192.168.1.0”, an address of the receiver host 20 is “192.168.1.1”, the port address of the receiver host 20 is “192.168.1.2” and the broad cast address of a subnet allocated to the host 20 is “192.168.1.3”. In this case, if a plurality of receivers belonging to the same group exist when a multicast packet is being relayed, the subordinate router can distribute the multicast packet to the respective receiver hosts.

### SUMMARY OF THE INVENTION

It is an object of this invention to provide a network interconnection method capable of reducing a line occupancy rate and improving band utilization efficiency, an apparatus therefor and a system using the apparatus.

According to one aspect of the present invention, there is provided a network interconnection method for connecting a plurality of receiver hosts and a backbone network through first and second relay units and relaying a packet, wherein the receiver hosts build a virtual network for receiving a multicast packet; when receiving the packet from the backbone network, the first relay unit determines whether the packet is the multicast packet, specifies the virtual network to the packet and specifies a port of the second relay unit to which the virtual network belongs if the packet is the multicast packet, and transfers the packet to the specified port; and the second relay unit receives the transferred packet, determines whether the packet is the multicast packet, and, if the packet is the multicast packet, transfers the multicast packet to ports to which the respective receiver hosts building the virtual network are connected.

According to another aspect of the present invention, there is provided a network interconnection apparatus including first and second relay units connected between a plurality of receiver hosts and a backbone network, and relaying a packet, the plurality of receiver hosts building a virtual network for receiving a multicast packet, wherein the first relay unit comprises: a first determination unit which determines whether the packet received from the backbone network is the multicast packet; a specifying unit which specifies the virtual network to the packet according to a determination result of the determination unit; a first storage unit which stores information on the virtual network and information on a port of the second relay unit to which the virtual network belongs; and a first transfer unit which retrieves the port of the second relay unit to which the virtual network belongs from a content of the storage unit, and transfers the packet to the retrieved port, and the second relay unit comprises: a second determination unit which receives the transferred packet, and determines whether the packet is the multicast packet; a second storage unit which storing the information on the virtual network and the information on the port to which the virtual network belongs; and a second transfer unit which transfers the port to which the virtual network belongs from a content of the second storage unit according to a determination result of the second determination unit, and transfers the packet to the retrieved packet.

According to still another aspect of the present invention, there is provided a network interconnection system comprising: a plurality of receiver hosts; a backbone network; and a network interconnection apparatus interposed between the receiver hosts and the backbone network and relaying a packet, wherein the receiver hosts build a virtual network for receiving a multicast packet; the network interconnection apparatus consists of the network interconnection apparatus according to the fifth to seventh aspects; and the multicast packet is transferred from the first relay unit to the port of the second relay unit to which the virtual network belongs.

Other objects and features of this invention will become understood from the following description with reference to the accompanying drawings.

### BRIEF DESCRIPTION OF THE DRAWINGS

FIG. 1 is a block diagram showing the configuration of a network interconnection system in the first embodiment according to the present invention;

FIG. 2 is a block diagram showing the configuration of an edge router shown in FIG. 1;

FIG. 3 is a block diagram showing one example of a multicast forwarding table included in a layer 3 relay processing section shown in FIG. 2;

FIG. 4 is a block diagram showing one example of the configuration of a unicast forwarding table included in the layer 3 relay processing section shown in FIG. 2;

FIG. 5 is a block diagram showing the frame configuration of a packet if no tag is added to the packet;

FIG. 6 is a block diagram showing the frame configuration of a packet if a tag is added to the packet;

FIG. 7 is a block diagram showing the frame configuration of TCI shown in FIG. 6;

FIG. 8 is a block diagram showing one example of the configuration of a forwarding table included in the layer 2 relay processing section 12c shown in FIG. 2;

FIG. 9 is a block diagram showing one example of the configuration of a multicast forwarding table included in a layer 3 relay processing section 12d shown in FIG. 2;

FIG. 10 is a flow chart for explaining the packet transfer operation of the edge router;

FIG. 11 is a flow chart for explaining the packet transfer operation of a subordinate router;

FIG. 12 is a block diagram showing one example of the configuration of a port VLAN ID table included in the subordinate router;

FIG. 13 is a block diagram showing the configuration of a network interconnection system in the second embodiment according to the present invention;

FIG. 14 is a block diagram showing the configuration of a network interconnection system in the third embodiment according to the present invention; and

FIG. 15 is a block diagram showing the configuration of a conventional network interconnection system.

### DETAILED DESCRIPTION

The present invention has been achieved in order to solve the following problems.

If the L3-connection is established for individual users, it is necessary to allocate subnets to the respective users. If so, as stated above, four times as many as addresses are required, for example, to thereby disadvantageously consume an address space which is depleted.

The embodiments of a network interconnection method, an apparatus therefor and a system using the apparatus according to the present invention will be explained hereinafter with reference to the accompanying drawings.

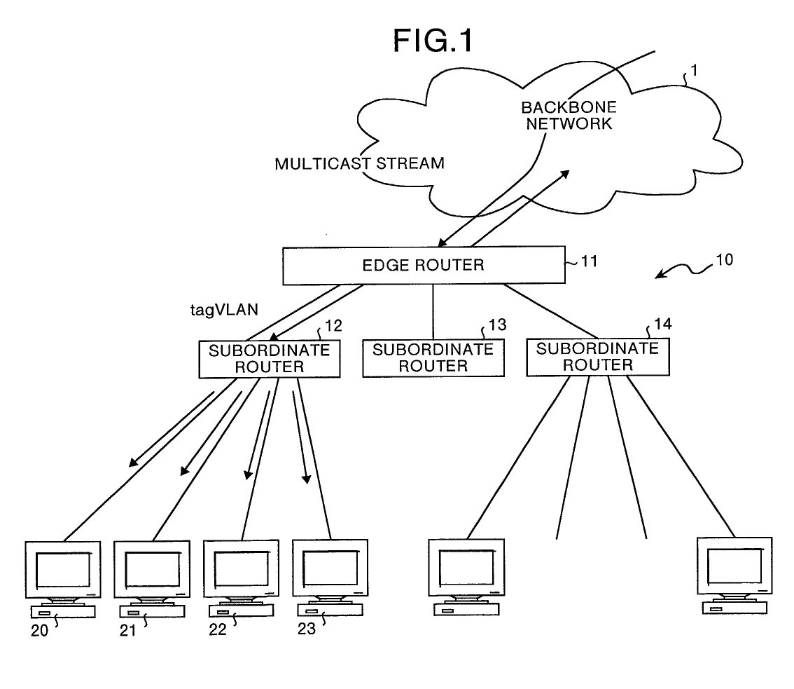

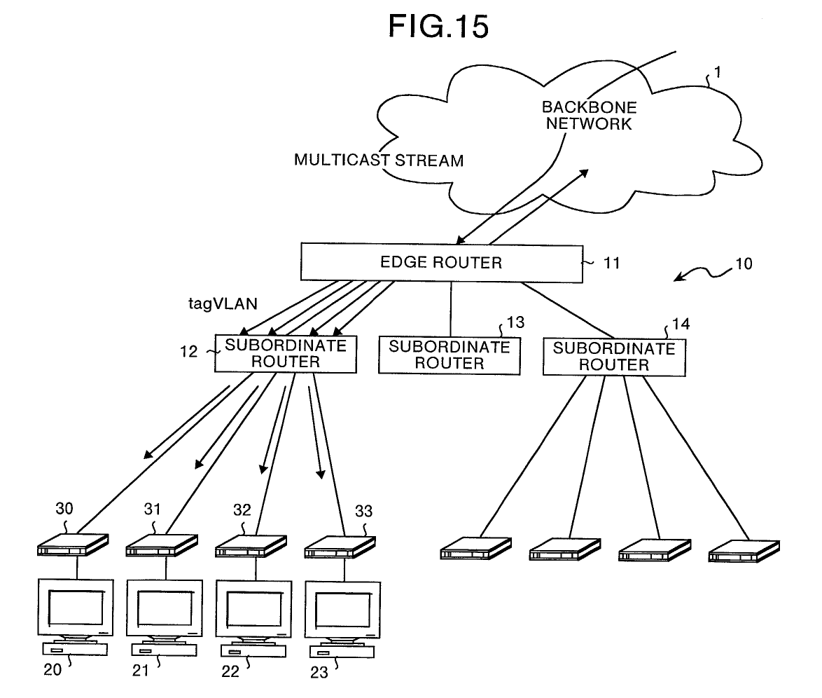

FIG. 1 is a block diagram showing the configuration of a network interconnection system in the first embodiment according to the present invention. The configuration shown in FIG. 1 differs from that shown in FIG. 15 in that receiver hosts 20 to 23 are directly connected to a subordinate router 12. A tag-added multicast stream packet is transmitted from an edge router 11 of L3 to each of subordinate routers 12 to 14 of L2. Each of the subordinate routers 12 to 14 which receives this packet transfers the received packet to receiver hosts 20 to 23 which belong to a tag VLAN, respectively.

Consequently, in this embodiment, one multicast packet is transmitted to one group address on the line between the edge router 11 and each of the subordinate routers 12 to 14 and each of the subordinate routers 12 to 14 copies the packet and transfers the copied packet to the receiver hosts 20 to 23, respectively.

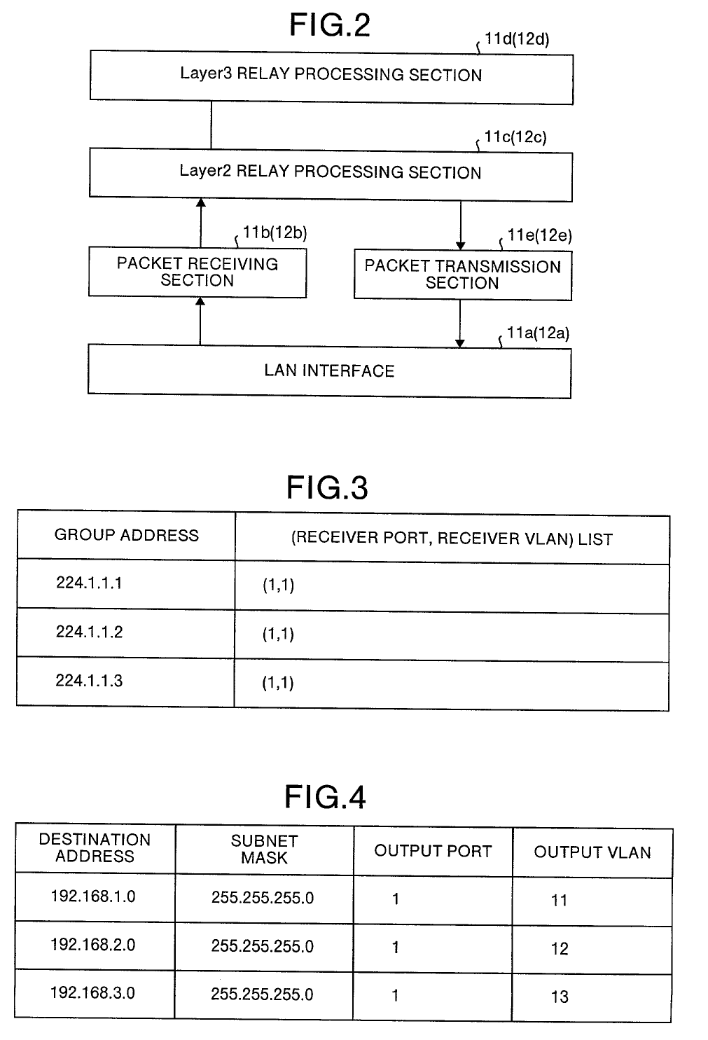

As shown in FIG. 2, in this system, the edge router 11 consists of a LAN interface 11a connected to a backbone network 1 and the respective subordinate routers 12 to 14 through ports, a packet receiving section 11b receiving a packet captured by the LAN interface 11a and conducting a receiving processing to the packet, a layer 2 relay processing section 11c conducting a relay processing to the layer 2 MAC of the packet received by the packet receiving section 11b, a layer 3 relay processing section 11d conducting a relay processing to the layer 3 IP of the received packet, and a packet transmission section 11e transmitting the packet processed by the respective relay processing sections 11c and 11d.

FIG. 3 is a block diagram showing one example of the configuration of a multicast forwarding table included in the layer 3 relay processing section 11d. This table stores multicast group IP addresses, and list information on the numbers of the receiver ports of the LAN interface 11a, to which subordinate routers reaching receiver hosts in the same group are connected, and the numbers of receiver VLAN's indicating multicast.

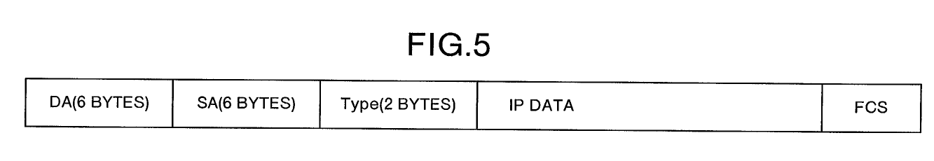

FIG. 4 is a block diagram showing one example of the configuration of a unicast forwarding table included in the layer 3 relay processing section 11d. This table consists of destination IP addresses indicating destination receiver hosts, subnet masks, the output ports of the LAN interface 11a to which the subordinate routers reaching the receiver hosts are connected, and output VLAN's indicating the identification numbers of VLAN's to which packets having the respective destination IP addresses belong.

If no tag is added, the frame configuration of a packet transmitted and received in this system consists of an MAC destination address, a sender address, a packet type, IP data and an FCS such as checksum as shown in FIG. 5.

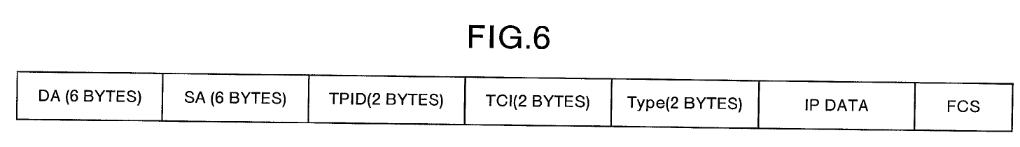

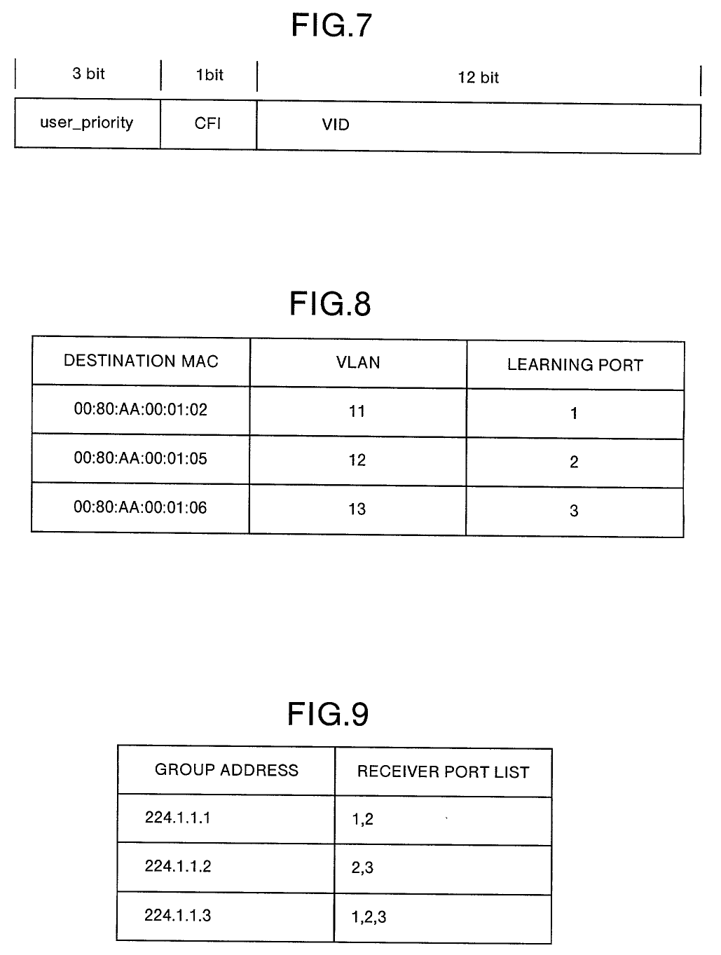

If a tag is added, the frame configuration of the packet consists of an MAC destination address, a sender address, a TPID (Tag Protocol Identifier) for identifying a tag protocol, and TCI (Tag Control Information) as shown in FIG. 6. In this embodiment, the TIPD is 0x8100. The TCI consists of user priority indicating the degree of priority of a user, a CFI (Canonical Format Indicator), and a VID storing the identification number of the VLAN for logically identifying the VLAN as shown in FIG. 7.

The configuration of each of the subordinate routers 12 to 14 is the same as that of the edge router 11 shown in FIG. 2. FIG. 2 typically shows the configuration of the subordinate router 12. It is noted that the constituent elements of the subordinate router 12 are denoted by parenthesized reference symbols to discriminate from the constituent elements of the edge router 11.

The subordinate router 12 consists of a LAN interface 12a connected to the edge router 11 and the receiver hosts 20 to 23 through ports, a packet receiving section 12b receiving a packet captured by the LAN interface 12a and discriminating the type of the packet, a layer 3 relay processing section 12d conducting a relay processing to the layer 3 IP of the packet received by the packet receiving section 12b, and a packet transmission section 12e transmitting the packet processed by the respective relay processing sections 12c and 12d.

FIG. 8 is a block diagram showing one example of the configuration of a forwarding table included in the layer 2 relay processing section 12c. This table consists of destination MAC addresses indicating destination receiver hosts, VLAN's indicating the identification numbers of VLAN's to which the receiver hosts having the respective addresses belong, and learning ports to which the respective receiver hosts are connected.

FIG. 9 is a block diagram showing one example of the configuration of a multicast forwarding table included in the layer 3 relay processing section 12d. This table stores multicast group IP addresses, and list information on the numbers of the receiver ports of the LAN interface 12a to which receiver hosts belonging to the respective groups are connected.

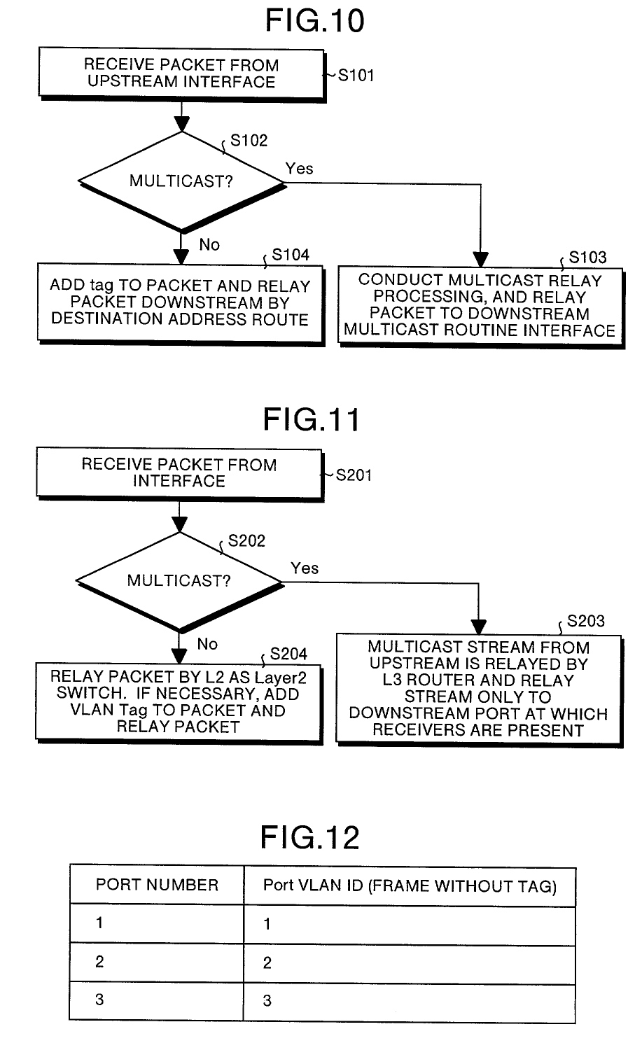

The packet transfer operation of this network interconnection system will be described based on flow charts shown in FIGS. 10 and 11. FIG. 10 is a flow chart for explaining the packet transfer operation of the edge router 11.

A transmission host, not shown, in the backbone network 1 creates the packet without a tag shown in FIG. 5 by storing the destination IP address of the receiver host, the sender address of the transmission host and the other information in the packet. The destination MAC address is determined from the multicast destination IP address. In case of unicast, the MAC address of a router near the transmission host is stored in the packet. The packet thus created is transmitted to the edge router 11 through the backbone network 1 from the interface of the transmission host.

In FIG. 10, the packet receiving section 11b receives the packet from the LAN interface 11a connected to the backbone network 1 (in a step 101). This received packet is output to the layer 2 relay processing section 11c. The layer 2 relay processing section 11c and the layer 3 relay processing section 11d connected to the layer 2 relay processing section 11c determine whether this received packet is a multicast packet or a unicast packet (in a step 102).

In this step 102, the layer 2 relay processing section 11c makes a determination based on whether the destination MAC address of the received packet is the MAC address of the router 11 itself or the multicast MAC address determined by the multicast destination IP address.

If the destination MAC address is the MAC address of the router 11 itself or the multicast MAC address, this packet is output to the layer 3 relay processing section 11d. If the destination MAC address is the other MAC address, the packet is subjected to the relay processing by the layer 2 relay processing section 11c and transmitted from the packet transmission section 11e.

If the packet is input into the layer 3 relay processing section 11d, the layer 3 relay processing section 11d determines whether the destination IP address in the IP data of this packet is the IP address of the router 11 itself or the address of the receiver host.

If the destination IP address is the IP address of the router 11 itself, the layer 3 relay processing section 11d determines that this packet is a unicast packet addressed to the router 11 itself. In addition, if the layer 2 relay processing section 11c determines the destination MAC address as the multicast MAC address and the layer 3 relay processing section 11d determines the destination IP address as the multicast IP address, then the packet is determined as a multicast packet, the multicast forwarding table shown in FIG. 3 is retrieved, the output port of the LAN interface 11a is defined as “1”, the layer 2 relay processing section 11c performs a transmission processing for allocating a corresponding tag to the packet and then the packet is transmitted from the packet transmission section 11e (in a step 103).

In this case, the layer 2 relay processing section 11c inputs the value of the receiver VLAN shown in FIG. 3 into the VID shown in FIG. 7 for the above-stated packet and creates a tag-added packet. The packet thus created is relayed to the receiver port of the LAN interface 11a indicated in the multicast forwarding table and forwarded from this LAN interface 11a to the subordinate router 12.

If the layer 2 relay processing section 11c determines the destination MAC address as the MAC address of the router 11 itself and the layer 3 relay processing section 11d determines the destination IP address as the IP address of the receiver host, then the packet is determined as a unicast packet addressed to this receiver host, the unicast forwarding table shown in FIG. 4 is retrieved, the output port of the LAN interface 11a is defined as “1”, the layer 2 relay processing section 11c performs a transmission processing for adding a VLAN identifier to the packet and the resultant packet is transmitted from the packet transmission section 11e (in a step 104).

In this case, the layer 2 relay processing section 11c retrieves the identification number of the output VLAN by the destination address route shown in FIG. 4 for the above-stated packet, stores this identification number in the VID of the TCI and thereby creates a tag-added packet. The packet thus created is relayed to the output port of the LAN interface 11a indicated by the unicast forwarding table and forwarded to the subordinate router 12 from this LAN interface 11a.

As shown in the flow chart of FIG. 11, in the subordinate router 12, the packet receiving section 12b receives the packet from the LAN interface 12a at the port to which the edge router 11 is connected (in a step 201). The packet receiving section 12b determines whether this received packet is a multicast packet or a unicast packet based on the MAC destination address of the received packet and the IP destination address in the IP data of the packet (in a step 202).

If this received packet is the multicast packet, the layer 3 relay processing section 12d conducts a multicast relay processing to the received packet, namely, retrieves the receiver port list for the group address shown in FIG. 9 and relays a multicast stream only to this port (in a step 203).

If this received packet is the unicast packet, the layer 2 relay processing section 12c conducts a relay processing to the received packet, namely, retrieves aport to which the receiver host is connected from the destination MAC address and the value of the VLAN identification number shown in FIG. 8 and relays the received packet to this learning port (in a step 204) and forwards the packet from this LAN interface to the receiver host connected to the learning port.

As can be seen, in the first embodiment, the edge router transmits the packet with the tag specifying the VLAN to which the receiver host to receive the multicast packet belongs, to the port of the subordinate router to which this VLAN belongs. The subordinate router receives the transferred multicast packet, copies the packet and then transfers the copied packet to the port to which each receiver host building the VLAN is connected. Due to this, only by transmitting one packet on the line between the both routers, the subordinate router copies the packet according to the number of receiver ports and forwards the copied packet to each receiver host. It is, therefore, possible to reduce a line occupancy rate and to thereby improve band utilization efficiency.

It is noted that the present invention may be applied to a case where packets in different multicast groups exist such as the delivery of different contents. In this case, an identifier specifying a VLAN to which receiver hosts to receive, for example, a multicast packet belong is added to the packet and the packet is unicast to the receiver hosts for each group. In this embodiment, if the multicast packet is received, a tag specifying the VLAN to which the receiver hosts to receive the multicast packet belong is added to the packet and the packet is then transmitted. By doing so, it suffices to transmit only one multicast packet from the edge router to the subordinate router and the subordinate router can transfer the packet to each receiver host. Thus, it is possible to dispense with creating copies of the same multicast stream for each tag VLAN, thereby making it possible to improve transmission efficiency, to reduce a line occupancy rate and to improve band utilization efficiency.

In case of receiving the unicast packet, by relaying the packet by L2 level, it is not required to provide unnecessary L3 subnets, thereby making it possible to effectively utilize an address space in address allocation.

In the first embodiment, the tag is added to the packet to thereby specify the VLAN to which the receiver hosts to receive the multicast packet belong. The present invention should not be limited to this embodiment. It is also possible to define a state without a tag shown in FIG. 5 as a state of specifying the VLAN stated above.

In that case, if the packet without a tag is received between the edge router 11 and each of the subordinate routers 12 to 14, this packet is preset to be recognized as a certain VLAN. In this example, a port VLAN ID table shown in FIG. 12 is provided in the subordinate router, the port VLAN identifier (PVID) of the VLAN is allocated to this table for each receiving port receiving the packet transmitted from the edge router and the table stores the port VLAN identifier (PVID). If the packet input into each port is a packet without a tag, the subordinate router can specify the VLAN by retrieving this table.

It is noted that this port number may be the number of a physical port or the number of a logical port which is logically set for this physical port. In addition, the edge router 11 may be provided with a table storing the PVID of the VLAN allocated for each transmission port transmitting the packet as in the case of the port VLAN ID table.

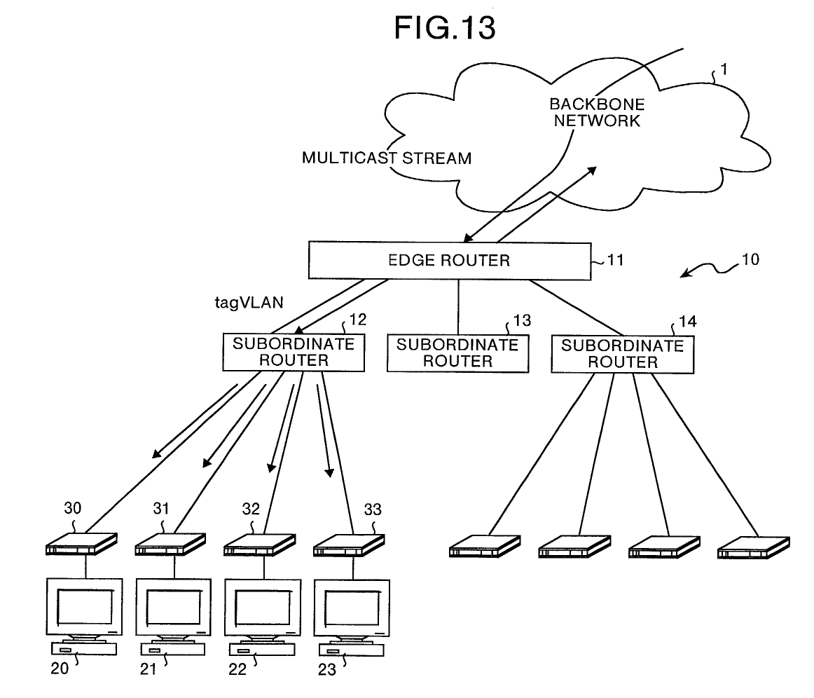

FIG. 13 is a block diagram showing the configuration of a network interconnection system in the second embodiment according to the present invention. In FIG. 13, CE routers 30 to 30 are interposed between subordinate routers and receiver hosts, respectively. Each of the CE routers 30 to 33 has an IGMP (Internet Group Management Protocol) Proxy function. This enables the receiver hosts 20 to 23 to transmit an IGMP membership report to the subordinate router 12 through the respective CE routers 30 to 33 and enables the subordinate router 12 to forward a necessary multicast packet only to a port receiving this membership report when receiving the membership report.

In the second embodiment, each of the subordinate routers 12 to 14 is provided with a management table storing the group IP address of a multicast packet to be received by this receiver (CE router) and the port number of the interface to which this CE router is connected. Each of the subordinate routers 12 to 14 can specify a port from which the multicast packet is transmitted by retrieving the management table.

In the second embodiment, the same, single multicast packet is transmitted from the edge router 11 to each of the subordinate routers 12 to 14 using a tag VLAN, and the same multicast packet is copied and forwarded only to a port receiving an IGMP membership report using this membership report from each of the subordinate routers 12 to 14 to the receiver hosts 20 to 23. It is, therefore, possible to reduce a line occupancy rate, to improve band utilization efficiency and to shorten time required for each subordinate router to transmit a packet.

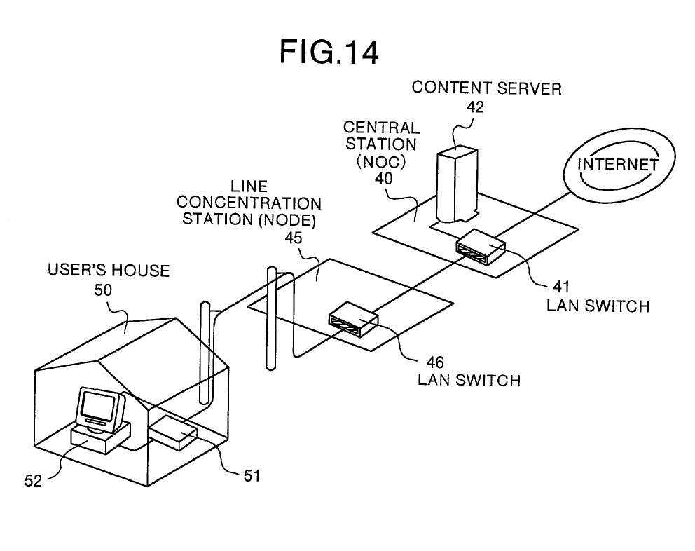

As shown in, for example, FIG. 14, the network interconnection system according to the present invention can be applied to a constant connection network system for FTTH (Fiber to the Home) service. In FIG. 14, a LAN switch 41 and a content server 42 exist in a central station 40, a LAN switch 46 exists in a line concentrating station 45, and a media converter 51 and a receiver host 52 exist in a user's house 50.

Even with the above-stated configuration, it is possible to provide either the LAN witch 41 or 46 with multicast forwarding control and IGMP control functions as in the case of the first embodiment and to provide a delivery service by the content server 42. Further, besides the above-stated elements, a unit which authenticates a user can be provided in the central station 40 or in the Internet network to thereby conduct authentication control together with the above-stated controls.

In the second embodiment as in the case of the first embodiment, the LAN switch 41 has a multicast forwarding control function to thereby transmit a packet with a tag specifying a VLAN to which receiver hosts to receive a multicast packet belong, to the port of the LAN switch 46 to which this VLAN belongs, and the LAN switch 46 receives the transferred multicast packet, copies the packet and then transfers the copied packet to ports connected to each of the receiver hosts building the VLAN. Due to this, only by transmitting one packet on a line between the both switches, the LAN switch 46 copies the packet according to the number of receiver ports and forwards the copied packet to the receiver hosts, respectively, thereby making it possible to reduce a line occupancy rate and to improve band utilization efficiency.

While the VLAN is recognized using the tag added to the MAC packet and the packet is transferred to the corresponding port in this embodiment, the present invention should not be limited thereto. Any identifier is available as long as the identifier can recognize a port to which the packet is to be transferred.

The present invention should not be limited to the above-stated embodiments and various changes and modifications can be made within the scope of the invention.

As stated so far, according to the present invention, an edge router specifies a VLAN to which a receiver host to receive a multicast packet belongs and transmits the packet to a subordinate router, and the subordinate router receiving the packet transfers the packet to each receiver host which belong to the VLAN. Due to this, one multicast packet is transmitted on a line between, for example, the edge router of L3 and the subordinate router of L2 and the subordinate router of L2 transfers the packet to each receiver host, thereby making it possible to reduce a line occupancy rate and to improve band utilization efficiency.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A network interconnection method for connecting a plurality of receiver hosts and a backbone network through first and second relay units and relaying a packet, wherein
said receiver hosts build a virtual network for receiving a multicast packet;
when receiving the packet from the backbone network, said first relay unit determines whether the packet is the multicast packet, specifies the virtual network to the packet and specifies a port of said second relay unit to which the virtual network belongs if the packet is the multicast packet, and transfers the packet to the specified port; and
said second relay unit receives the transferred packet, determines whether the packet is the multicast packet, and, if the packet is the multicast packet, transfers the multicast packet to ports to which the respective receiver hosts building the virtual network are connected.

2. The network interconnection method according to claim 1, wherein
said receiver hosts build the virtual network for each multicast group and build the virtual network for receiving all multicast packets; and
if the received packet is the multicast packet, said first relay unit specifies the virtual network for receiving the multicast packet and specifies the port of said second relay unit to which the virtual network belongs.

3. The network interconnection method according to claim 1, wherein
in the network interconnection method, the virtual network is specified by adding or not adding an identifier to the packet.

4. The network interconnection method according to claim 1, wherein
in the network interconnection method, a third relay unit having an IGMP proxy function is provided between said second relay unit and the receiver hosts;
said third relay unit transmits an IGMP membership report from each of said receiver host to said second relay unit; and
said second relay unit forwards the multicast packet to a port receiving the membership report.

5. A network interconnection apparatus comprising first and second relay units connected between a plurality of receiver hosts and a backbone network, and relaying a packet, the plurality of receiver hosts building a virtual network for receiving a multicast packet, wherein
said first relay unit comprises:
a first determination unit which determines whether the packet received from the backbone network is the multicast packet;
a specifying unit which specifies the virtual network to the packet according to a determination result of the determination unit;
a first storage unit which stores information on the virtual network and information on a port of said second relay unit to which the virtual network belongs; and
a first transfer unit which retrieves the port of the second relay unit to which the virtual network belongs from a content of the storage unit, and transfers the packet to the retrieved port, and
said second relay unit comprises:
a second determination unit which receives the transferred packet, and determines whether the packet is the multicast packet;
a second storage unit which stores the information on the virtual network and the information on the port to which the virtual network belongs; and
a second transfer unit which transfers the port to which the virtual network belongs from a content of the second storage unit according to a determination result of the second determination unit, and transfers the packet to the retrieved packet.

6. The network interconnection apparatus according to claim 5, wherein
said network interconnection apparatus comprises a third relay unit having an IGMP proxy function and provided between said second relay unit and the receiver hosts;
said third relay unit transmits an IGMP membership report from each of said receiver hosts to said second relay unit; and
said second relay unit forwards the multicast packet to a port receiving the membership report.

7. The network interconnection apparatus according to claim 5, wherein
the specifying unit specifies the virtual network by adding or not adding an identifier to the packet.

8. A network interconnection system comprising: a plurality of receiver hosts; a backbone network; and a network interconnection apparatus interposed between said receiver hosts and the backbone network and relaying a packet, wherein
said receiver hosts build a virtual network for receiving a multicast packet;
said network interconnection apparatus comprises first and second relay units connected between the plurality of receiver hosts building the virtual network for receiving the multicast packet and the backbone network, and relaying the packet;
said first relay unit comprises:
a first determination unit which determines whether the packet received from the backbone network is the multicast packet;
a specifying unit which specifies the virtual network to the packet according to a determination result of the determining unit;
a first storage unit which stores information on the virtual network and information on a port of said second relay unit to which the virtual network belongs; and
a first transfer unit which retrieves the port of the second relay unit to which the virtual network belongs from a content of the storage unit, and transfers the packet to the retrieved port,
said second relay unit comprises:
a second determination unit which receives the transferred packet, and determines whether the packet is the multicast packet;
a second storage unit which stores the information on the virtual network and the information on the port to which the virtual network belongs; and
a second transfer unit which transfers the port to which the virtual network belongs from a content of the second storage unit according to a determination result of the second determining unit, and transfers the packet to the retrieved packet, and
the multicast packet is transferred from the first relay unit to the port of the second relay unit to which the virtual network belongs.

9. The network interconnection system according to claim 8, wherein
said network interconnection apparatus comprises a third relay unit having an IGMP proxy function and provided between said second relay unit and the receiver hosts;
said third relay unit transmits an IGMP membership report from each of said receiver hosts to said second relay unit; and
said second relay unit forwards the multicast packet to a port receiving the membership report.

10. The network interconnection system according to claim 8, wherein
the specifying unit specifies the virtual network by adding or not adding an identifier to the packet.
